(19) United States
(12) Patent Application Publication
(10) Pub. No.: US 2024/0008000 A1
(43) Pub. Date: Jan. 4, 2024

(54) DATA TRANSMISSION METHOD AND APPARATUS AND SYSTEM

(71) Applicant: FUJITSU LIMITED, Kawasaki-shi (JP)

(72) Inventors: Guorong LI, Beijing (CN); Pengyu JI, Beijing (CN); Jian ZHANG, Beijing (CN); Xin WANG, Beijing (CN)

(73) Assignee: FUJITSU LIMITED, Kawasaki-shi (JP)

(21) Appl. No.: 18/370,425

(22) Filed: Sep. 20, 2023

Related U.S. Application Data
(63) Continuation of application No. PCT/CN2021/084769, filed on Mar. 31, 2021.

(51) Int. Cl. H04W 72/02; H04W 72/563; H04W 76/28; H04W 72/25

(52) U.S. Cl. CPC H04W 72/02; H04W 72/563; H04W 76/28; H04W 72/25

(57) ABSTRACT

A data transmission apparatus, configured in a first terminal equipment, the first terminal equipment performing sidelink transmission to a second terminal equipment, the second terminal equipment performing sidelink discontinuous reception (SL DRX), the data transmission apparatus includes a processor configured to determine a sidelink resource, and select a destination associated with the sidelink resources in a logical channel prioritization (LCP) procedure, and a transmitter configured to transmit the sidelink transmission to the second terminal equipment to which the selected destination corresponds, wherein the sidelink resource being located within the SL DRX active time to which the destination corresponds.

### CROSS REFERENCE TO RELATED APPLICATION

This application is a continuation application of International Application PCT/CN2021/084769 filed on Mar. 31, 2021, and designated the U.S., the entire contents of which are incorporated herein by reference.

### FIELD

This disclosure relates to the field of communication technologies.

### BACKGROUND

In Release 17 of existing standards, enhancement to the New Radio (NR) sidelink is power saving, which enables a terminal equipment with battery limitations to perform sidelink operations in a power efficient manner. A design of NR sidelink of Release 16 in the existing standards is based on an assumption that a terminal equipment is always online during sidelink operations, such as focusing only on a terminal equipment installed in a vehicle with a sufficient battery capacity. In Release 17, a power saving solution is required for vulnerable road users (VRUs), pedestrian users in all Vehicle to Everything (V2X) application scenarios and terminal equipments that require minimal power consumption in public safety and commercial scenarios.

In existing standards, in order to save power, downlink discontinuous reception (DRX) may be configured for a terminal equipment. When DRX is configured for the terminal equipment, the terminal equipment does not need to continuously monitor a physical downlink control channel (PDCCH).

Currently, for sidelink DRX (SL DRX), the radio access network second group (RAN2) of the Third Generation Partner Program (3GPP) has agreed the following contents:
for sidelink unicast (SL unicast), for example, after the link of an SL unicast is established, SL DRX configuration may be configured according to each pair of source address and destination address;
for sidelink groupcast (SL groupcast) and sidelink broadcast (SL broadcast), SL DRX configuration may be commonly configured, with a granularity of the configuration needing to be studied;
for data reception, a behavior of monitoring reception of sidelink control information (SCI) during an active time of SL DRX is defined; here, the SCI refers to a physical sidelink control channel (PSCCH) and second stage SCI on a physical sidelink shared channel (PSSCH), abbreviated as 2nd stage SCI; and
for data reception, a terminal equipment may skip monitoring a PSCCH and 2nd stage SCI during an inactive time of SL DRX.

Currently, in a procedure of sidelink multiplexing and assembling, during logical channel prioritization (LCP) procedure, when a transmitting equipment (Tx UE) receives a sidelink resource from a network device or autonomously selects a sidelink resource, for new transmission, it will select a destination, i.e. a destination equipment or receiving equipment (Rx UE) to which data of the new transmission are transmitted, then select a logical channel corresponding to the selected destination, and thereafter, allocate sidelink resources. In existing standards, during the destination selection procedure, the transmitting equipment may select a destination where a logical channel or MAC CE with highest logical channel priority is located.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

It was found by the inventors that in a case where the receiving equipment (Rx UE) is configured with SL DRX, the Rx UE may skip monitoring a physical sidelink control channel (PSCCH) and second stage sidelink control information (2nd stage SCI) carried in a physical sidelink shared channel (PSSCH) during an inactive time of SL DRX, thereby skipping reception of SL transmission. Therefore, the Tx UE may need to obtain relevant information on SL DRX configuration of the Rx UE and so on, or determine relevant information by itself on SL DRX configuration of the Rx UE and so on, so as to transmit sidelink transmission (SL transmission) to the Rx UE during an active time of SL DRX of the Rx UE.

However, when a Tx UE performs sidelink transmission to more than one Rx UEs:
in a case of mode-1, a network device may allocate an SL grant according to a sidelink buffer status report (SL-BSR) transmitted by the Tx UE to the network device, but a resource indicated by the SL grant (referred to as an SL grant or SL resource) may not necessarily be within the active time of SL DRX of the Rx UE; even if the network device learns relevant information, such as SL DRX configuration of one or more Rx UEs, for example, the Tx UE reports relevant information, such as SL DRX configuration of one or more Rx UEs, to the network device, or the network device determines relevant information of one or more Rx UEs, such as SL DRX configuration; as the network device is only able to allocate SL grants according to logical channels (LCH) to which a logical channel group (LCG) corresponds and their priorities in the SL-BSR report, and is unable to learn a destination where a logical channel or an MAC CE with highest logical channel priority is located selected by the Tx UE in a subsequent LCP (logical channel prioritization) procedure, a resource indicated by the SL grant allocated by the network device may fall outside an active time of SL DRX to which the destination selected by the Tx UE during the LCP procedure corresponds, that is, an SL resource where a sidelink media access control protocol data unit (SL MAC PDU) transmitted by the Tx UE is located may fall outside the active time of SL DRX to which a destination of the SL MAC PDU corresponds, thereby resulting in that an Rx UE of the destination is unable to correctly receive sidelink transmission on the resource indicated by the SL grant; and
in a case of mode-2, an SL grant (or SL resource) is selected by the Tx UE autonomously; even if the Tx UE takes relevant information into account when selecting SL resources, such as SL DRX configuration of one or more Rx UEs, a logical channel or an MAC CE with highest logical channel priority in a subsequent LCP procedure may possibly change, thereby resulting in that the destination selected in the LCP procedure may possibly be different from a destination referenced when selecting SL resources; hence, the SL resource may fall outside an active time of SL DRX to which the destination selected by the Tx UE during the LCP procedure corresponds, that is, an SL resource where a SL MAC PDU transmitted by the Tx UE is located may fall outside the active time of SL DRX to which a destination of the SL MAC PDU corresponds, thereby resulting in that an Rx UE of the destination is unable to correctly receive sidelink transmission on the SL resource.

In order to solve at least one of the above problems, embodiments of this disclosure provide a data transmission method, apparatus and system.

According to an aspect of the embodiments of this disclosure, there is provided a data transmission apparatus, configured in a first terminal equipment, the first terminal equipment performing sidelink transmission to a second terminal equipment, the second terminal equipment using sidelink discontinuous reception (SL DRX), wherein the apparatus includes:
a determining unit configured to determine sidelink resources;
a selecting unit configured to select a destination associated with the sidelink resources in a logical channel prioritization (LCP) procedure; and
a transmitting unit configured to transmit the sidelink transmission to the second terminal equipment to which the selected destination corresponds.

According to another aspect of the embodiments of this disclosure, there is provided a data transmission apparatus, configured in a first terminal equipment, the first terminal equipment performing sidelink transmission to a second terminal equipment, the second terminal equipment using sidelink discontinuous reception (SL DRX), wherein the apparatus includes:
a determining unit configured to determine sidelink resources;
a selecting unit configured to select a destination in a logical channel prioritization (LCP) procedure, wherein the sidelink resources are located within an SL DRX active time to which the destination corresponds; and
a transmitting unit configured to transmit the sidelink transmission to the second terminal equipment to which the selected destination corresponds.

According to a further aspect of the embodiments of this disclosure, there is provided a resource scheduling apparatus, configured in a network device, the network device allocating sidelink resources for a first terminal equipment, wherein the apparatus includes:
a receiving unit configured to receive relevant information of an SL DRX active time transmitted by the first terminal equipment, the relevant information of an SL DRX active time including SL DRX active time information to which a destination or a pair of source ID and destination ID corresponds; and
an allocating unit configured to allocate sidelink resources for the first terminal equipment according to the relevant information of an SL DRX active time.

An advantage of the embodiments of this disclosure exists in that by selecting a destination associated with an SL grant during an LCP procedure, or selecting a destination making an SL grant to be within SL DRX active time to which the destination corresponds during an LCP procedure, sidelink transmission using the resources indicated by the SL grant is transmitted within the SL DRX active time of the destination to which the SL grant corresponds, and the Rx UE to which the destination corresponds may correctly receive the sidelink transmission.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiments.

FIG. 1 is schematic diagram of a DRX cycle;

FIG. 2 is a schematic diagram of a scenario where a transmitting equipment performs sidelink transmission to more than one receiving equipments;

FIG. 3 is a schematic diagram of the data transmission method of an embodiment of this disclosure;

FIG. 4 is a schematic diagram of another scenario where the transmitting equipment performs sidelink transmission to more than one receiving equipments;

FIG. 5 is a schematic diagram of the data transmission method of an embodiment of this disclosure;

FIG. 6 is a schematic diagram of a further scenario where the transmitting equipment performs sidelink transmission to more than one receiving equipments;

FIG. 7 is a schematic diagram of the data transmission method of an embodiment of this disclosure;

FIG. 8 is another schematic diagram of the data transmission method of the embodiment of this disclosure;

FIG. 9 is a schematic diagram of the resource scheduling method of an embodiment of this disclosure;

FIG. 10 is a schematic diagram of the data transmission apparatus of an embodiment of this disclosure;

FIG. 11 is a schematic diagram of the data transmission apparatus of an embodiment of this disclosure;

FIG. 12 is a schematic diagram of the data transmission apparatus of an embodiment of this disclosure;

FIG. 13 is another schematic diagram of the data transmission apparatus of the embodiment of this disclosure;

FIG. 14 is a schematic diagram of the resource scheduling apparatus of an embodiment of this disclosure;

FIG. 15 is a schematic diagram of the terminal equipment of an embodiment of this disclosure; and

FIG. 16 is a schematic diagram of the network device of an embodiment of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and New Radio (NR) in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a node and/or donor in an IAB architecture, a base station (BS), an access point (AP), a transmission reception point (TRP), a broadcast transmitter, a mobile management entity (MME), a gateway, a server, a radio network controller (RNC), a base station controller (BSC), etc.

In the embodiment, the base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE) or terminal device” refers to, for example, an equipment accessing to a communication network and receiving network services via a network device. The terminal equipment may be fixed or mobile, and may also be referred to as a mobile station (MS), a terminal, a subscriber station (SS), an access terminal (AT), and a station, etc.

In the embodiment, the terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above. In this text, “device” may refer to a network device, and may also refer to a terminal equipment, except otherwise specified.

Scenarios of the embodiments of this disclosure shall be described below by way of examples; however, this disclosure is not limited thereto.

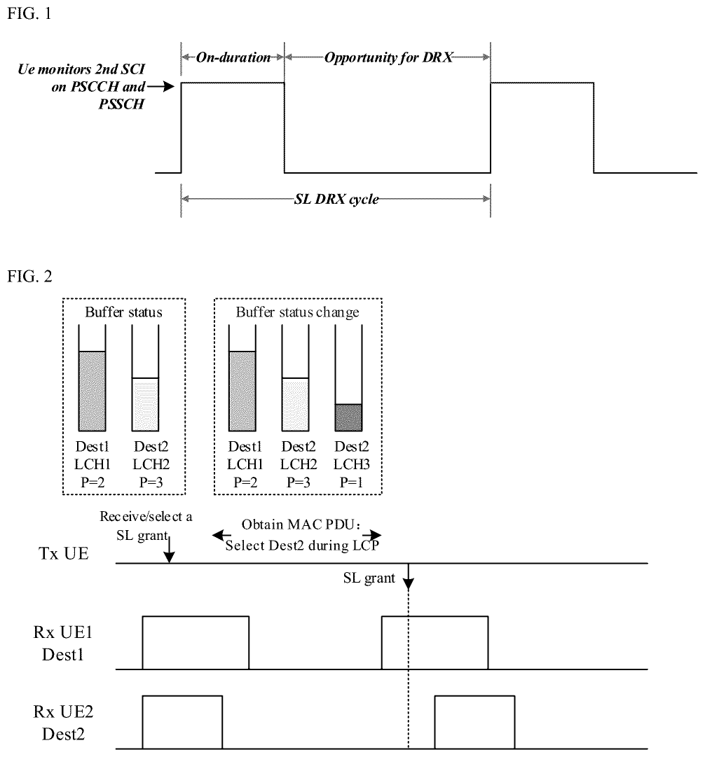

FIG. 1 is schematic diagram of an SL DRX cycle. As shown in FIG. 1, an SL DRX cycle specifies an on-duration and possible inactivity times (opportunities for DRX) thereafter. The on-duration is a duration waiting for receiving SCI (such as monitoring a first stage SCI in a PSCCH and/or a second stage SCI in a PSSCH) after a terminal equipment wakes up. If a terminal equipment successfully decodes SCI used for scheduling a new transmission transmitted to itself, the terminal equipment keeps awake and starts an inactivity timer. The inactivity timer refers to a duration waiting for successfully decoding the SCI starting from the last of successfully decoding the SCI by the terminal equipment in; and if the SCI is not successfully decoded within time of the inactivity timer, the terminal equipment will turn back to a sleep state, and the terminal equipment needs to start the inactivity timer after a single time of successfully decoding the SCI that is only used for initial transmission.

In the embodiments of this disclosure, an active time of SL DRX refers to a total time monitoring SCI (such as monitoring a PSCCH and monitoring a second stage SCI in a PSSCH) by a terminal equipment in, including an on-duration of an SL DRX cycle, a time of performing continuous reception by the terminal equipment when the inactivity timer does not expire, and a time of performing continuous reception by the terminal equipment while waiting for a retransmission opportunity.

In the embodiment of this disclosure, DRX configuration may further include a retransmission timer, which specifies a time duration of expecting that there will exist retransmission.

FIG. 2 is a schematic diagram of a scenario where a transmitting equipment (Tx UE) performs sidelink transmission to more than one receiving equipments (Rx UEs). As shown in FIG. 2, there exist two situations in this scenario. Situation 1: SL DRX configuration or an active time to which destination 1 or destination 2 corresponds is not taken into account in an SL grant allocated by a network device (mode-1) or an SL grant autonomously selected by the Tx UE (mode-2). Situation 2: SL DRX configuration or an active time is taken into account in an SL grant allocated by a network device (mode-1) or an SL grant autonomously selected by the Tx UE (mode-2), and when the Tx UE transmits an SL-BSR to the network device to request the network device for allocating an SL grant or when the Tx UE autonomously selects an SL grant, there exist LCH1 (with a priority 2) of destination 1 and LCH2 (with a priority 3) of destination 2 in a buffer of the Tx UE, hence, as the priority of LCH1 is relatively high, an active time of SL DRX to which destination 1 where LCH1 is located corresponds may be taken into account in the SL grant allocated by the network device or the SL grant autonomously selected by the Tx UE.

In the above two situations, when the Tx UE performs multiplexing and assembling the MAC PDU for the SL grant, during the LCP procedure, due to that new data arrive in LCH3 of destination 2 and the priority of LCH3 is highest (the priority is 1), the Tx UE may possibly select destination 2 where LCH3 is located as a destination of the MAC PDU and assemble the MAC PDU. However, as the resource indicated by the SL grant falls outside the SL DRX active time to which destination 2 corresponds, it will be resulted in that Rx UE 2 of destination 2 is unable to correctly receive sidelink transmission on the SL grant.

In order that the transmission resource (the resource indicated by the SL grant) of the sidelink transmission is within the active time of the SL DRX of the destination to which the sidelink transmission corresponds, so that the Rx UE of the destination is able to receive the sidelink transmission correctly, this disclosure is proposed.

In the embodiment of this disclosure, description is given by taking that a first terminal equipment perform sidelink transmission to a second terminal equipment as an example. In the embodiment, the second terminal equipment has or uses SL DRX, or the second terminal equipment is configured with SL DRX, or the second terminal equipment performs SL DRX operations, and so on. Here, the SL DRX configuration may be configured by a network device for the second terminal equipment, or may be preconfigured for the second terminal equipment, or may be configured by the first terminal equipment for the second terminal equipment via a sidelink (such as by using an RRC configuration sidelink message, etc.). Here, the sidelink transmission may include transmission of sidelink data or control information or feedback information or reference signals, etc. And furthermore, from the perspective of transmitting sidelink transmission, the first terminal equipment of the embodiments of this disclosure is a transmitting equipment (Tx UE), and the second terminal equipment is a receiving equipment (Rx UE).

The embodiments of this disclosure shall be described below with reference to the accompanying drawings and implementations.

### Embodiment of a First Aspect

The embodiment of this disclosure provides a data transmission method, which shall be described from a side of a first terminal equipment.

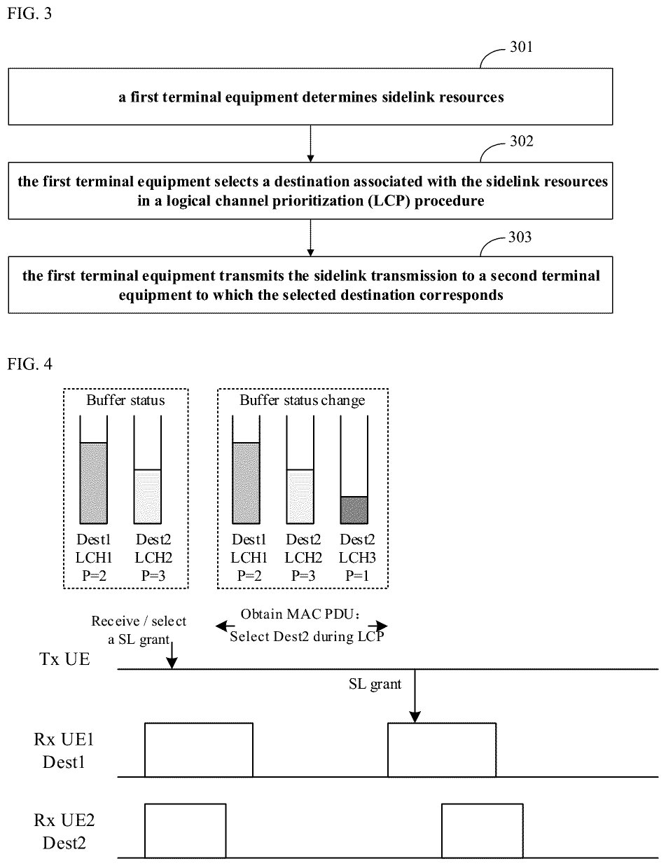

FIG. 3 is a schematic diagram of the data transmission method of the embodiment of this disclosure. As shown in FIG. 3, the method includes:
301: a first terminal equipment determines sidelink resources (SL grants or SL resources);
302: the first terminal equipment selects a destination associated with the sidelink resources in a logical channel prioritization (LCP) procedure; and
303: the first terminal equipment transmits the sidelink transmission to a second terminal equipment to which the selected destination corresponds.

It should be noted that FIG. 3 only schematically illustrate the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 3.

In the embodiment of this disclosure, “in an LCP procedure” may also be referred to as “in an MAC PDU assembly procedure” or “in an MAC PDU generation procedure” or “in an MAC PDU construction procedure”. Unless otherwise specified, in the description of various aspects of the embodiments below, “in an LCP procedure” may be replaced with “in an MAC PDU assembly procedure” or “in an MAC PDU generation procedure” or “in an MAC PDU construction procedure”.

In the above embodiment, the destination selected in the LCP procedure is consistent with the destination considered when the network device allocates the SL grants or the Tx UE autonomously selects the SL grants, so that the sidelink transmission using the resources indicated by the SL grants is transmitted within the SL DRX active time of the destination to which the SL grants correspond. Therefore, the Rx UE to which the destination corresponds may correctly receive the sidelink transmission.

In operation 301, for mode-1, the SL grants are allocated by the network device for the first terminal equipment, and for mode-2, the SL grants are selected autonomously by the first terminal equipment. In operation 301, the “determining” may also be expressed as “receiving”, “selecting”, “acquiring”, and “obtaining”, etc., which are not limited in this disclosure.

In operation 302, for mode-1, in some embodiments, the destination selected by the first terminal equipment in the LCP procedure and associated with the sidelink resources may be: a destination where a logical channel or an MAC CE having sidelink data to be transmitted is located when an SL-BSR is triggered or an MAC CE of an SL-BSR is generated or an MAC CE of an SL-BSR is transmitted, or may also be: a destination where a logical channel or an MAC CE with highest priority or a minimal packet delay budget (PDB) is located when an SL-BSR is triggered or an MAC CE of an SL-BSR is generated or an MAC CE of an SL-BSR is transmitted, or may also be: a destination where a logical channel or an MAC CE with highest priority or a minimal PDB is located when a scheduling request (SR) triggered by a sidelink logical channel (SL LCH) or a sidelink MAC CE is triggered or transmitted. Hence, it may be ensured that the destination selected by the first terminal equipment in the LCP procedure is in consistence with the destination considered by the network device in allocating the SL grants, so that the receiving equipment (the second terminal equipment) to which the destination corresponds may correctly receive the sidelink transmission.

The destination associated with sidelink resources is enumerated in the above examples. However, this disclosure is not limited thereto, and the destination associated with sidelink resources may also be any combination of the above examples.

In the above embodiment, the first terminal equipment may also transmit information related on an SL DRX active time to the network device, such as a serving base station (such as a serving gNB) or a serving cell of the first terminal equipment, so that the network device allocates SL grants for the first terminal equipment accordingly. In some embodiments, the information related on an SL DRX active time includes SL DRX active time information to which a destination or a pair of source ID and destination ID corresponds.

In some embodiments, the information related on an SL DRX active time includes SL DRX active time information corresponding to a destination or a pair of source ID and destination ID where a logical channel or MAC CE having a highest priority or having a priority higher than a specific value or having a minimum PDB or having latency requirement less than a specific value is located.

In some embodiments, the information related on an SL DRX active time includes SL DRX active time information to which all destinations or pairs of source IDs and destination IDs correspond.

In the above embodiment, with reference to the SL DRX active time information, the network device may allocate SL grants for the first terminal equipment. Therefore, the first terminal equipment may select a destination associated with the SL grants in the LCP procedure, so that the resources indicated by the SL grants allocated by the network device fall within the SL DRX active time of the destination associated with the SL grant, thereby ensuring that the Rx UE of the destination may monitor control information and/or data transmitted in the resources indicated by the SL grants.

In the above embodiment, the SL DRX active time information may be at least one of the following: a time period of an SL DRX on-duration timer; a time period of an SL DRX inactivity timer; a time period of an SL DRX retransmission timer; a slot where SL periodic transmission is located; a slot where initial transmission and/or retransmission indicated by SCI is located; and an upper bound of latency of sidelink channel state information (SL CSI) reporting. However, this disclosure is not limited thereto, and the SL DRX active time information may also be other information related on an SL DRX active time, which shall not be described herein any further.

In operation 302, for mode-2, in some embodiments, the destination selected by the first terminal equipment in the LCP procedure and associated with the sidelink resources may be a destination used by the first terminal equipment in a process of resource selection and/or reselection. Hence, it may be ensured that the destination selected by the first terminal equipment in the LCP procedure is in consistence with the destination considered by the first terminal equipment in autonomously selecting the SL grants, so that the receiving equipment (the second terminal equipment) to which the destination corresponds may correctly receive the sidelink transmission.

In some embodiments, the destination used by the first terminal equipment in a procedure of resource selection/reselection may be at least one of the following: a destination where a logical channel or MAC CE with highest priority or a minimal PDB is located when resource selection/reselection is triggered; a destination where a logical channel or an MAC CE having data to be transmitted is located; and a destination of a second terminal equipment needing coordination of sidelink resources. However, this disclosure is not limited thereto, and the destination used by the first terminal equipment in a procedure of resource selection/reselection may also be other destinations, which shall not be repeated herein any further.

In the above embodiment, when the first terminal equipment performs resource selection and/or reselection, such as in operation 301, there may be two methods.

Method 1: a physical layer of the first terminal equipment selects a sidelink resource subset according to assistance information to which the destination used in the procedure of resource selection/reselection corresponds and reports the sidelink resource subset to an MAC layer, such that the MAC layer selects the sidelink resources from the sidelink resource subset.

For example, the MAC layer of the first terminal equipment determines the destination used in the procedure of resource selection/reselection, transmits the assistance information to which the destination corresponds to the physical layer, and the physical layer selects sidelink resource subset according to the assistance information and reports the sidelink resource subset to the MAC layer. Hence, the MAC layer of the first terminal equipment may select the sidelink resources from the sidelink resource subset reported by the physical layer.

In the above method, the assistance information may be SL DRX active time information or sidelink available resources to which the destination corresponds. For example, the sidelink available resources may be determined according to the SL DRX configuration to which the destination corresponds, and the physical layer of the first terminal equipment may select sidelink resources within the SL DRX active time or sidelink available resources to constitute the sidelink resource subset.

Method 2: the MAC layer of the first terminal equipment selects the sidelink resources according to the assistance information to which the destination used in the procedure of resource selection/reselection corresponds.

For example, the MAC layer of the first terminal equipment determines the destination used in the procedure of resource selection/reselection, and selects the sidelink resources from the sidelink resource subset reported by the physical layer according to the assistance information to which the destination corresponds.

In the above method, the assistance information may be SL DRX active time information or sidelink available resources to which the destination corresponds. For example, the sidelink available resources may be determined according to the SL DRX configuration to which the destination corresponds, and the MAC layer of the first terminal equipment may select sidelink resources within the SL DRX active time or sidelink available resources from the sidelink resource subset reported by the physical layer.

In the above embodiment, similar with the SL DRX active time information in mode-1, the SL DRX active time information in mode-2 may be at least one of the following: a time period of an SL DRX on-duration timer; a time period of an SL DRX inactivity timer; a time period of an SL DRX retransmission timer; a slot where SL periodic transmission is located; a slot where initial transmission and/or retransmission indicated by SCI is located; and a upper bound of latency of sidelink channel state information (SL CSI) reporting. However, this disclosure is not limited thereto, and the SL DRX active time information may also be other information related on the SL DRX active time, which shall not be repeated herein any further.

FIG. 4 is a schematic diagram of another scenario where the transmitting equipment performs sidelink transmission to more than one receiving equipments.

As shown in FIG. 4, a destination considered when the network device allocates SL grants for the Tx UE (mode-1) or the Tx UE selects SL grants autonomously (mode-2) is destination 1, that is, the destination associated with the SL grants is destination 1, and in the LCP procedure, the Tx UE selects destination 1 associated with the SL grant as the destination. Due to that the destination selected by the Tx UE in the LCP procedure is consistent with the destination considered when the network device allocates the SL grants or the Tx UE selects the SL grants autonomously, both of which are destination 1, the SL transmission on the SL grants is transmitted within the SL DRX active time of the destination to which the SL grants correspond. Hence, the Rx UE to which the destination corresponds may correctly receive the SL transmission.

In the embodiment of this disclosure, there may possibly exist the following type of destination: a destination having a logical channel or MAC CE with highest priority, and a corresponding SL DRX active time does not include the above-described allocated or autonomously selected sidelink resources. For the convenience of explanation, this type of destination is referred to as a second destination, such as destination 2 shown in FIG. 4. And for the second destination, resources may be requested in the following method for transmitting corresponding sidelink transmission.

For example, for mode-1, the first terminal equipment may trigger an SR or SL-BSR, receive second sidelink resources allocated by the network device, and transmit second sidelink transmission to a second terminal equipment to which the second destination corresponds by using the second sidelink resources. In the embodiment, the SR may be an SR triggered by the logical channel with highest priority or an SR triggered by MAC CE with highest priority, with SR configuration to which the logical channel or MAC CE with highest priority corresponds, and the SL-BSR may be triggered by the logical channel with highest priority. In addition, the network device may allocate sidelink resources (referred to as second sidelink resources) for the first terminal equipment with reference to some other information, after receiving the above SR or SL-BSR transmitted by the first terminal equipment, and a specific allocation method is not limited in this disclosure.

In the above embodiment, optionally, the first terminal equipment may further transmit information related on an SL DRX active time to the network device, so that the network device allocates the second sidelink resources for the first terminal equipment with reference to the information. The information related on an SL DRX active time includes SL DRX active time information to which a destination or a pair of source ID and destination ID corresponds. The SL DRX active time information has been explained above, and shall not be described herein any further.

For example, for mode-2, the first terminal equipment may trigger resource selection and/or reselection to obtain the second sidelink resources, and transmit second sidelink transmission to the second terminal equipment to which the second destination corresponds by using the second sidelink resources. That is, following situations are added to triggering selection and/or reselection of transmission resources:
if the selected sidelink grant is not in the SL DRX active time corresponding to the destination with the highest priority logical channel or MAC CE, or,
if the selected sidelink grant is out of the SL DRX active time corresponding to the destination with the highest priority logical channel or MAC CE.

In the embodiment, the first terminal equipment may select a destination associated with the second sidelink resources in the logical channel prioritization (LCP) procedure, and the selected destination is the above-described second destination, and a specific selection method and LCP procedure is not limited in this disclosure. The LCP procedure has been explained above, and shall not be described herein any further.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

According to the method of the embodiment of this disclosure, by selecting a destination associated with an SL grant during an LCP procedure, the sidelink transmission using the resources indicated by the SL grant is transmitted within the SL DRX active time of the destination to which the SL grant corresponds, and the Rx UE to which the destination corresponds may correctly receive the sidelink transmission.

### Embodiment of a Second Aspect

The embodiment of this disclosure provides a data transmission method, which shall be described from a side of a first terminal equipment.

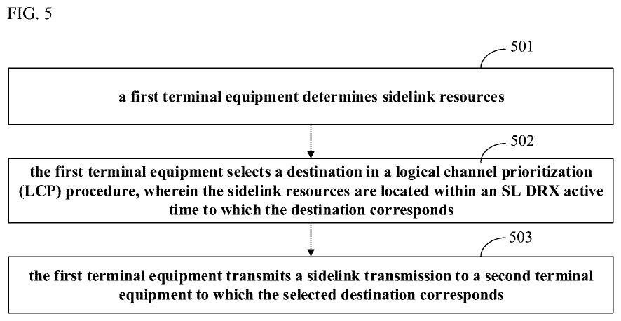

FIG. 5 is a schematic diagram of the data transmission method of the embodiment of this disclosure. As shown in FIG. 5, the method includes:
501: a first terminal equipment determines sidelink resources (SL grants or SL resources);
502: the first terminal equipment selects a destination in a logical channel prioritization (LCP) procedure, wherein the sidelink resources are located within an SL DRX active time to which the destination corresponds; and
503: the first terminal equipment transmits a sidelink transmission to a second terminal equipment to which the selected destination corresponds.

It should be noted that FIG. 5 only schematically illustrate the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 5.

In the above embodiment, when the first terminal equipment selects the destination in the LCP procedure, a principle of “making the SL grants allocated by the network device or the SL grants autonomously selected by the Tx UE within the SL DRX active time to which the selected destination corresponds” is followed. Hence, the sidelink transmission on the SL grants is transmitted within the SL DRX active time of the destination to which the SL grants correspond, and the Rx UE to which the destination corresponds may correctly receive the sidelink transmission.

In operation 501, for mode-1, the SL grants are allocated by the network device for the first terminal equipment, and for mode-2, the SL grants are selected autonomously by the first terminal equipment. In operation 501, the “determining” may also be expressed as “receiving”, “selecting”, “acquiring”, and “obtaining”, etc., which are not limited in this disclosure.

In operation 502, in some embodiments, the SL DRX active time to which the destination corresponds includes time length (or time-domain resource) of the sidelink resources, and the destination has a logical channel or MAC CE with highest priority satisfying predetermined condition. That is, in the LCP procedure, when the first terminal equipment selects a destination, not only a condition of “the destination has the logical channel or MAC CE with highest priority satisfying predetermined condition” needs to be satisfied, but also a condition of “the SL DRX active time to which the destination corresponds includes the time length of the sidelink resources” needs to be satisfied.

For example, following modification may be made to the standards:

5.22.1.4.1.2 Selection of logical channels

The MAC entity shall for each SCI corresponding to a new transmission:

| 1> | select a Destination associated to one of unicast, groupcast and broadcast, having | |
|---|---|---|
| | corresponding SL DRX active time including the time duration of the SL grant and | |
| | having at least one of the MAC CE and the logical channel with the highest priority, | |
| | among the logical channels that satisfy all the following conditions and MAC CE(s), if | |
| | any, for the SL grant associated to the SCI: | |
| | 2> | SL data is available for transmission; and |
| | 2> | SBj > 0, in case there is any logical channel having SBj > 0; and |
| | 2> | sl-configuredGrantType1Allowed, if configured, is set to true in case the SL grant is |
| | | a Configured Grant Type 1; and |
| | 2> | sl-AllowedCG-List, if configured, includes the configured grant index associated to |
| | | the SL grant; and |
| | 2> | sl-HARQ-FeedbackEnabled is set to disabled, if PSFCH is not configured for the SL |

grant associated to the SCI.
NOTE:
If multiple Destinations have the logical channels satisfying all conditions above with the same highest priority or if multiple Destinations have either the MAC CE and/or the logical channels satisfying all conditions above with the same priority as the MAC CE, which Destination is selected among them is up to UE implementation.

In operation 502, in some embodiments, the destination is a destination selected from third destinations and having a logical channel or MAC CE with highest priority satisfying a predetermined condition, and an SL DRX active time to which the third destinations correspond includes the time length (or time-domain resource) of the sidelink resources. That is, in the LCP procedure, when selecting a destination, the first terminal equipment selects a destination where a logical channel or MAC CE with highest priority satisfying the predetermined condition is located from destinations having a corresponding SL DRX active time including time length of SL grants.

That is, in the LCP procedure, when selecting a destination, the first terminal equipment first determines destinations with corresponding SL DRX active times includes time length (or time-domain resource) of SL grants, then determines a destination in thee destinations having a logical channel or MAC CE satisfying the predetermined condition with highest priority, and finally selects a destination including a logical channel or MAC CE with highest priority satisfying the predetermined condition. Or, in the LCP procedure, when selecting a destination, the first terminal equipment excludes destination(s) having no corresponding SL DRX active time including time length of SL grants, and selects a destination including a logical channel or MAC CE with highest priority and satisfying the predetermined condition from the remaining destinations.

For example, following modification may be made to the standards:

5.22.1.4.1.2 Selection of logical channels

The MAC entity shall for each SCI corresponding to a new transmission:

| 1> | select a Destination associated to one of unicast, groupcast and broadcast among the | |
|---|---|---|
| | destination(s) having corresponding SL DRX active time including the time | |
| | duration of the SL grant, having at least one of the MAC CE and the logical channel | |
| | with the highest priority, among the logical channels that satisfy all the following | |
| | conditions and MAC CE(s), if any, for the SL grant associated to the SCI: | |
| | 2> | SL data is available for transmission; and |
| | 2> | SBj > 0, in case there is any logical channel having SBj > 0; and |
| | 2> | sl-configuredGrantType1Allowed, if configured, is set to true in case the SL grant is |
| | | a Configured Grant Type 1; and |
| | 2> | sl-AllowedCG-List, if configured, includes the configured grant index associated to |
| | | the SL grant; and |
| | 2> | sl-HARQ-FeedbackEnabled is set to disabled, if PSFCH is not configured for the SL |

grant associated to the SCI.
NOTE:
If multiple Destinations have the logical channels satisfying all conditions above with the same highest priority or if multiple Destinations have either the MAC CE and/or the logical channels satisfying all conditions above with the same priority as the MAC CE, which Destination is selected among them is up to UE implementation.

In operation 502, in some embodiments, the destination is a fourth destination having a logical channel or MAC CE with highest priority satisfying the predetermined condition, wherein when an SL DRX active time to which the fourth destination corresponds includes the time length (time-domain resource) of the sidelink resources, a priority of the logical channel and/or MAC CE included in the fourth destination is increased, that is, a value of the priority is reduced. That is, in the LCP procedure, when the first terminal equipment selects a destination, if an SL DRX active time to which a destination corresponds includes the time length (time-domain resource) of the SL grant, a priority of a logical channel of the destination is increased, and then a destination is selected in an existing method, i.e. a destination where a logical channel or MAC CE with highest priority satisfying the predetermined condition is selected.

In the above embodiment, increasing the priority of the logical channel of the destination is such as subtracting an offset from a value of the priority the logical channel of the destination (the higher the value of the priority, the lower the priority); and if the priority of the logical channel of the destination has reached the highest priority, the value of the priority of the logical channel of the destination may be set to be a negative number or 0, or the highest priority is kept.

In operation 502, in some embodiments, the destination is a fifth destination having a logical channel or MAC CE with highest priority satisfying the predetermined condition, wherein an SL DRX active time to which the fifth destination corresponds includes the time length (or time-domain resource) of the sidelink resources, and the fifth destination has a high priority.

That is, in the LCP procedure, when the first terminal equipment selects a destination, if an SL DRX active time to which a destination corresponds includes the resource or time length indicated by the SL grants, the destination is of a high priority, and then a destination where a logical channel or MAC CE with a highest priority satisfying the predetermined condition is located is selected from destinations of high priorities and taken as a destination of a generated MAC PDU.

In operation 502, in some embodiments, the destination is a sixth destination having a logical channel or MAC CE with highest priority satisfying the predetermined condition, wherein an SL DRX active time to which the sixth destination corresponds does not include the time length (or time-domain resource) of the sidelink resources, and the sixth destination has a low priority.

That is, in the LCP procedure, when the first terminal equipment selects a destination, if an SL DRX active time to which a destination corresponds does not include the resource or time length indicated by the SL grants, the destination is of a low priority, and then a destination where a logical channel or MAC CE with highest priority satisfying the predetermined condition is located is selected from destinations of non-low priorities and taken as a destination of a generated MAC PDU.

In the above embodiment, the predetermined condition refers to conditions “>2” in the LCP procedure, and reference may be made to the words in the above standard for details.

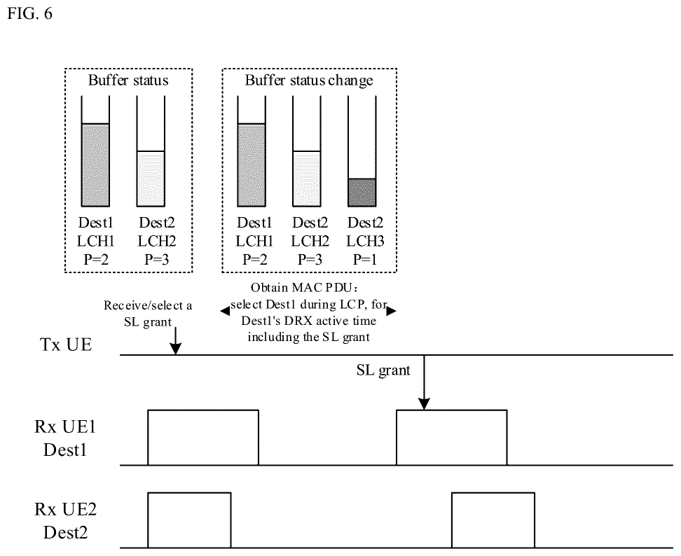

FIG. 6 is a schematic diagram of a further scenario where the transmitting equipment (Tx UE) performs sidelink transmission to more than one receiving equipments (Rx UEs).

As shown in FIG. 6, regardless of the SL grants allocated by the network device for the Tx UE (mode-1) or the SL grants autonomously selected by the Tx UE (mode-2), the Tx UE selects destination 1 having a corresponding SL DRX active time containing the time length (or time-domain resource) of the SL grants as the destination in the LCP procedure. As the SL DRX active time to which the destination selected by the Tx UE in the LCP procedure corresponds includes the time length (or time-domain resource) of the SL grants allocated by the network device or the SL grant autonomously selected by the Tx UE, the SL transmission on the SL grants is transmitted in the SL DRX active time of the destination to which the SL grants correspond. Hence, the Rx UE to which the destination corresponds may correctly receive the SL transmission.

In the embodiment of this disclosure, there may possibly exist the following type of destination: a destination having a logical channel or MAC CE with highest priority, and a corresponding SL DRX active time does not include the above-described allocated or autonomously selected sidelink resources. For the convenience of explanation, this type of destination is referred to as a second destination, such as destination 2 shown in FIG. 6. And for the second destination, resources may be requested in the following method for transmitting corresponding sidelink transmission.

For example, for mode-1, the first terminal equipment may trigger an SR or SL-BSR, receive second sidelink resources allocated by the network device, and transmit second sidelink transmission to a second terminal equipment to which the second destination corresponds by using the second sidelink resources. In the embodiment, the SR may be an SR triggered by the logical channel with highest priority or an SR triggered by the MAC CE with highest priority, with SR configuration to which the logical channel or MAC CE with highest priority corresponds, and the SL-BSR may be triggered by the logical channel with highest priority. In addition, the network device may allocate sidelink resources (referred to as second sidelink resources) for the first terminal equipment with reference to some other information, after receiving the above SR or SL-BSR transmitted by the first terminal equipment, and a specific allocation method is not limited in this disclosure.

In the above embodiment, optionally, the first terminal equipment may further transmit information related on an SL DRX active time to the network device, so that the network device allocates the second sidelink resources for the first terminal equipment with reference to the information. The information related on an SL DRX active time includes SL DRX active time information to which a destination or a pair of source ID and destination ID corresponds. The information related on an SL DRX active time has been explained above, and shall not be described herein any further.

For example, for mode-2, the first terminal equipment may trigger resource selection and/or reselection to obtain the second sidelink resources, and transmit second sidelink transmission to the second terminal equipment to which the second destination corresponds by using the second sidelink resources. That is, following situations are added to triggering selection and/or reselection of transmission resources:
if the selected sidelink grant is not in the SL DRX active time corresponding to the destination with the highest priority logical channel or MAC CE, or,
if the selected sidelink grant is out of the SL DRX active time corresponding to the destination with the highest priority logical channel or MAC CE.

In the embodiment, the first terminal equipment may select a destination associated with the second sidelink resources in the logical channel prioritization (LCP) procedure, and the selected destination is the above-described second destination, and a specific selection method and LCP procedure is not limited in this disclosure. The LCP procedure has been explained above, and shall not be described herein any further.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

According to the method of the embodiment of this disclosure, the first terminal equipment selects a destination with a corresponding SL DRX active time containing the allocated or autonomously selected SL grants in the LCP procedure, so that the sidelink transmission on the SL grant is transmitted within the SL DRX active time of the destination to which the SL grant corresponds, and the Rx UE to which the destination corresponds may correctly receive the sidelink transmission.

### Embodiment of a Third Aspect

The embodiment of this disclosure provides a data transmission method, which shall be described from a side of a first terminal equipment. The method is applicable to a destination (a second destination) having a logical channel or MAC CE with highest priority, and an SL DRX active time to which the second destination corresponds does not include sidelink resources allocated by a network device or autonomously selected by a first transmitting equipment.

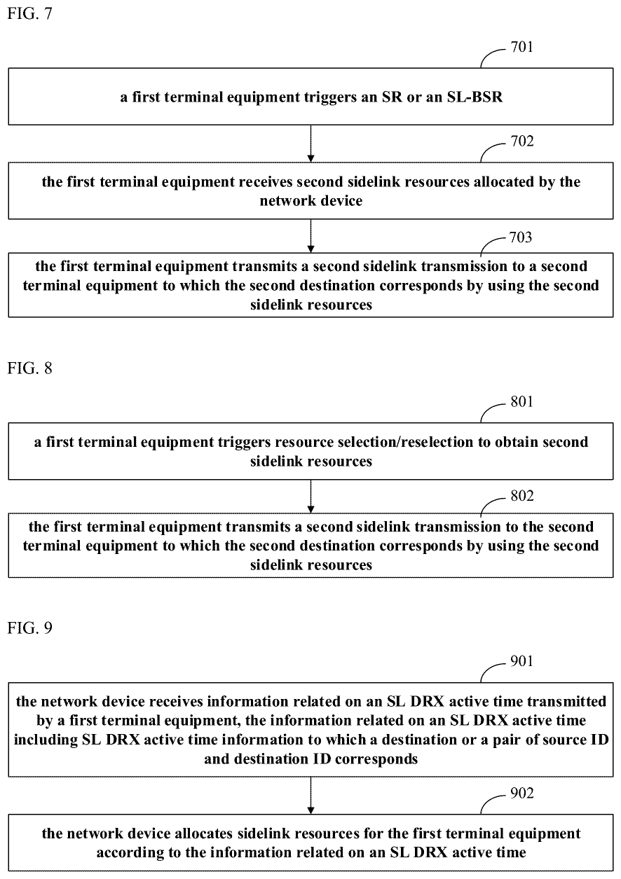

FIG. 7 is a schematic diagram of the data transmission method of the embodiment of this disclosure. As shown in FIG. 7, the method includes:
701: a first terminal equipment triggers an SR or an SL-BSR;
702: the first terminal equipment receives second sidelink resources allocated by the network device; and
703: the first terminal equipment transmits a second sidelink transmission to a second terminal equipment to which the second destination corresponds by using the second sidelink resources.

In the above embodiment, for the second destination, in mode-1, the first terminal equipment may trigger an SR or SL-BSR, receive second sidelink resources allocated by the network device, and transmit second sidelink transmission to a second terminal equipment to which the second destination corresponds by using the second sidelink resources.

In the embodiment, the SR may be an SR triggered by a logical channel with highest priority or an SR triggered by an MAC CE with highest priority, with SR configuration to which the logical channel or MAC CE with highest priority corresponds, and the SL-BSR may be triggered by the logical channel with highest priority. In addition, the network device may allocate sidelink resources (referred to as second sidelink resources) for the first terminal equipment with reference to some other information, after receiving the above SR or SL-BSR transmitted by the first terminal equipment, and a specific allocation method is not limited in this disclosure.

In the above embodiment, optionally, the first terminal equipment may further transmit information related on an SL DRX active time to the network device, so that the network device allocates the second sidelink resources for the first terminal equipment with reference to the information. The information related on an SL DRX active time includes SL DRX active time information to which a destination or a pair of source ID and destination ID corresponds. The SL DRX active time information has been explained above, and shall not be described herein any further.

FIG. 8 is another schematic diagram of the data transmission method of the embodiment of this disclosure. As shown in FIG. 8, the method includes:
801: a first terminal equipment triggers resource selection/reselection to obtain second sidelink resources; and
802: the first terminal equipment transmits a second sidelink transmission to the second terminal equipment to which the second destination corresponds by using the second sidelink resources.

In the above embodiment, for the second destination, in mode-2, the first terminal equipment may trigger resource selection and/or reselection to obtain the second sidelink resources, and transmit a second sidelink transmission to the second terminal equipment to which the second destination corresponds by using the second sidelink resources. That is, following situations are added to triggering selection and/or reselection of transmission resources:
if the selected sidelink grant is not in the SL DRX active time corresponding to the destination with the highest priority logical channel or MAC CE, or,
if the selected sidelink grant is out of the SL DRX active time corresponding to the destination with the highest priority logical channel or MAC CE.

In the embodiment, the first terminal equipment may select a destination associated with the second sidelink resources in the logical channel prioritization (LCP) procedure, and the selected destination is the above-described second destination, and a specific selection method and LCP procedure is not limited in this disclosure. The LCP procedure has been explained above, and shall not be described herein any further.

According to the embodiment of this disclosure, the Rx UE to which the second destination corresponds may correctly receive the sidelink transmission.

### Embodiment of a Fourth Aspect

The embodiment of this disclosure provides a resource scheduling method, which shall be described from a side of a network device. The network device is, for example, a network device in mode-1 in the embodiments of the first to third aspects, and is used to allocate sidelink resources for a transmitting equipment (the first terminal equipment in the embodiments of the first to third aspects) in mode-1, with contents identical to those in the embodiments of the first to third aspects being not going to be described herein any further.

The embodiments of the fourth aspect may be combined with the embodiments of the first to third aspects, or may be implemented separately, with contents identical to those in the embodiments of the first to third aspects being not going to be described herein any further.

FIG. 9 is a schematic diagram of the resource scheduling method of the embodiment of this disclosure. As shown in FIG. 9, the method includes:
901: the network device receives information related on an SL DRX active time transmitted by a first terminal equipment, the information related on an SL DRX active time including SL DRX active time information to which a destination or a pair of source ID and destination ID corresponds; and
902: the network device allocates sidelink resources for the first terminal equipment according to the information related on an SL DRX active time.

It should be noted that FIG. 9 only schematically illustrate the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 9.

In some embodiments, the information related on an SL DRX active time includes SL DRX active time information corresponding to a destination or a pair of source ID and destination ID where a logical channel or MAC CE having a highest priority or having a priority higher than a specific value or having a minimum PDB or having latency requirement less than a specific value is located.

In some embodiments, the information related on an SL DRX active time includes SL DRX active time information to which all destinations or pairs of source IDs and destination IDs correspond.

In the above embodiment, the network device may allocate SL grants for the first terminal equipment with reference to the SL DRX active time information. Therefore, the first terminal equipment may select a destination associated with the SL grants in the LCP procedure, so that the resources indicated by the SL grants allocated by the network device fall within the SL DRX active time of the destination associated with the SL, thereby ensuring that the Rx UE of the destination may monitor control information and/or data transmitted in the resources indicated by the SL grants.

In the above embodiment, the SL DRX active time information may be at least one of the following: a time period of an SL DRX on-duration timer; a time period of an SL DRX inactivity timer; a time period of an SL DRX retransmission timer; a slot where SL periodic transmission is located; a slot where initial transmission and/or retransmission indicated by SCI is located; and a upper bound of latency of sidelink channel state information (SL CSI) reporting.

According to the method of the embodiment of this disclosure, the sidelink resources where the sidelink transmission is located may be made to be located within the DRX active time of the receiving equipment, especially in the case of more than one receiving equipments, it is beneficial for the receiving equipment to correctly receive the sidelink transmission transmitted to itself.

### Embodiment of a Fifth Aspect

The embodiment of this disclosure provides a data transmission apparatus.

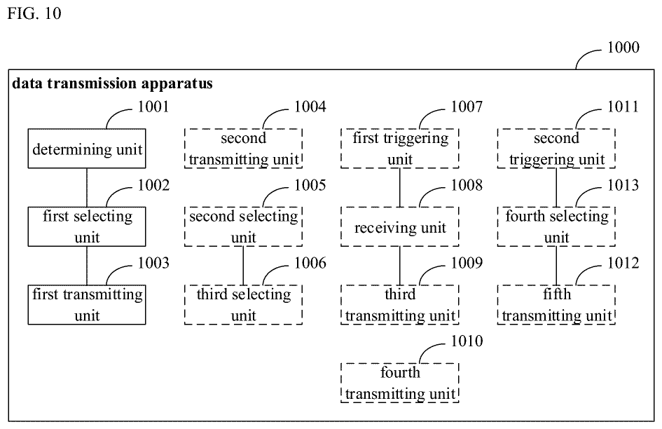

FIG. 10 is a schematic diagram of the data transmission apparatus of the embodiment of this disclosure. The apparatus may be a terminal equipment (such as the first terminal equipment described above), or may be one or some components or assemblies configured in the terminal equipment, with contents identical to those in the embodiment of the first aspect being not going to be described herein any further.

As shown in FIG. 10, the data transmission apparatus 1000 includes a determining unit 1001, a first selecting unit 1002 and a first transmitting unit 1003.

In the embodiment of this disclosure, the determining unit 1001 is configured to determine sidelink resources; the first selecting unit 1002 is configured to select a destination associated with the sidelink resources in a logical channel prioritization (LCP) procedure; and the first transmitting unit 1003 is configured to transmit the sidelink transmission to the second terminal equipment to which the selected destination corresponds.

In some embodiments, in mode-1, the destination associated with the sidelink resources is at least one of the following:
a destination where a logical channel or an MAC CE having data to be transmitted is located when a sidelink buffer status report (SL-BSR) is triggered or a control unit of a media access control (MAC CE) of an SL-BSR is generated or an MAC CE of an SL-BSR is transmitted;
a destination where a logical channel or an MAC CE having a highest priority or a minimal packet delay budget (PDB) is located when an SL-BSR is triggered or an MAC CE of an SL-BSR is generated or an MAC CE of an SL-BSR is transmitted; and
a destination where a logical channel or an MAC CE having a highest priority or a minimal PDB is located when a scheduling request (SR) triggered by a sidelink logical channel (SL LCH) or a sidelink MAC CE is triggered or transmitted.

In the above embodiment, as shown in FIG. 10, the data transmission apparatus 1000 further includes:
a second transmitting unit 1004 configured to transmit information related on an SL DRX active time to a network device, the information related on the SL DRX active time including SL DRX active time information to which a destination or a pair of source ID and destination ID corresponds.

In some embodiments, the information related on an SL DRX active time includes SL DRX active time information corresponding to a destination or a pair of source ID and destination ID where a logical channel or MAC CE having a highest priority or having a priority higher than a specific value or having a minimum PDB or having latency requirement less than a specific value is located.

In some embodiments, the information related on an SL DRX active time includes SL DRX active time information to which all destinations or pairs of source IDs and destination IDs correspond.

In the above embodiment, the SL DRX active time information is at least one of the following: a time period of an SL DRX on-duration timer; a time period of an SL DRX inactivity timer; a time period of an SL DRX retransmission timer; a slot where SL periodic transmission is located; a slot where initial transmission and/or retransmission indicated by SCI is located; and a latency upper limit of sidelink channel state information (SL CSI) reporting.

In some embodiments, in mode-2, the destination associated with the sidelink resources is a destination used by the first terminal equipment in a procedure of resource selection and/or reselection (resource (re)selection).

In the above embodiment, the destination used by the first terminal equipment in a procedure of resource selection and/or reselection is at least one of the following: a destination where a logical channel or an MAC CE having a highest priority or a minimal PDB is located when resource selection and/or reselection is triggered; a destination where a logical channel or an MAC CE having data to be transmitted is located; and a destination of a second terminal equipment needing coordination of sidelink resources.

In some embodiment, as shown in FIG. 10, the data transmission apparatus 1000 further includes:
a second selecting unit 1005 configured to determine the destination in the procedure of resource selection and/or reselection at the MAC layer of the first terminal equipment, transmit assistance information to which the destination corresponds to the physical layer of the first terminal equipment, select a sidelink resource subset at the physical layer of the first terminal equipment according to the assistance information and report the sidelink resource subset to the MAC layer, and select the sidelink resources from the sidelink resource subset at the MAC layer of the first terminal equipment.

In the above embodiment, the assistance information is SL DRX active time information or sidelink available resources to which the destination corresponds, and at the physical layer of the first terminal equipment, the second selecting unit 1005 selects sidelink resources within the SL DRX active time or sidelink available resources to constitute the sidelink resource subset.

In some embodiment, as shown in FIG. 10, the data transmission apparatus 1000 further includes:
a third selecting unit 1006 configured to determine the destination used in the procedure of resource selection and/or reselection at the MAC layer of the first terminal equipment, and select the sidelink resources from the sidelink resource subset reported by the physical layer of the first terminal equipment according to the assistance information to which the destination corresponds.

In the above embodiment, the assistance information is SL DRX active time information or sidelink available resources to which the destination corresponds, and at the MAC layer of the first terminal equipment, the third selecting unit 1006 selects sidelink resources within the SL DRX active time or sidelink available resources from the sidelink resource subset.

In the embodiment is this disclosure, the SL DRX active time information is at least one of the following: a time period of an SL DRX on-duration timer; a time period of an SL DRX inactivity timer; a time period of an SL DRX retransmission timer; a slot where SL periodic transmission is located; a slot where initial transmission and/or retransmission indicated by SCI is located; and a upper bound of latency of sidelink channel state information (SL CSI) reporting.

In some embodiment, in mode-1, if there exists a second destination having a logical channel or MAC CE with a highest priority and an SL DRX active time to which the second destination corresponds does not include the sidelink resources, as shown in FIG. 10, the data transmission apparatus 1000 further includes:
a first triggering unit 1007 configured to trigger an SR or an SL-BSR;
a receiving unit 1008 configured to receive second sidelink resources allocated by the network device; and
a third transmitting unit 1009 configured to transmit a second sidelink transmission to a second terminal equipment to which the second destination corresponds by using the second sidelink resources.

In the above embodiment, optionally, as shown in FIG. 10, the data transmission apparatus 1000 further includes:
a fourth transmitting unit 1010 configured to transmit information related on an SL DRX active time, the information related on an SL DRX active time including SL DRX active time information to which a destination or a pair of source ID and destination ID corresponds.

In some embodiments, in mode-2, if there exists a second destination having a logical channel or MAC CE with a highest priority and an SL DRX active time to which the second destination corresponds does not include the sidelink resources, as shown in FIG. 10, the data transmission apparatus 1000 further includes:
a second triggering unit 1011 configured to trigger resource selection/reselection to obtain second sidelink resources; and
a fifth transmitting unit 1012 configured to transmit a second sidelink transmission to the second terminal equipment to which the second destination corresponds by using the second sidelink resources.

In the above embodiment, optionally, as shown in FIG. 10, the data transmission apparatus 1000 further includes:
a fourth selecting unit 1013 configured to select a destination associated with the second sidelink resources in the logical channel prioritization (LCP) procedure, the selected destination being the second destination.

It should be noted that the components or modules related to this disclosure are only described above. However, this disclosure is not limited thereto, and the data transmission apparatus 1000 may further include other components or modules, and reference may be made to related techniques for particulars of these components or modules.

Furthermore, for the sake of simplicity, connection relationships between the components or modules or signal profiles are only illustrated in FIG. 10. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

According to the data transmission apparatus of the embodiment of this disclosure, the sidelink resources where the sidelink transmission is located may be made to be located within the DRX active time of the receiving equipment, especially in the case of more than one receiving equipments, it is beneficial for the receiving equipment to correctly receive the sidelink transmission transmitted to itself.

### Embodiment of a Sixth Aspect

The embodiment of this disclosure provides a data transmission apparatus.

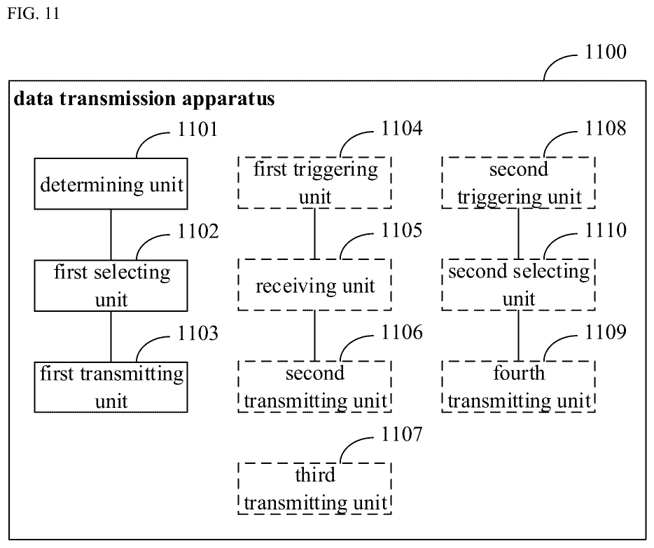

FIG. 11 is a schematic diagram of the data transmission apparatus of the embodiment of this disclosure. The apparatus may be a terminal equipment (such as the first terminal equipment described above), or may be one or some components or assemblies configured in the terminal equipment, with contents identical to those in the embodiment of the second aspect being not going to be described herein any further.

As shown in FIG. 11, the data transmission apparatus 1000 includes a determining unit 1101, a first selecting unit 1102 and a first transmitting unit 1103.

In the embodiment of this disclosure, the determining unit 1101 is configured to determine sidelink resources; the first selecting unit 1102 is configured to select a destination in a logical channel prioritization (LCP) procedure, wherein the sidelink resources are located within an SL DRX active time to which the destination corresponds; and the first transmitting unit 1103 is configured to transmit a sidelink transmission to the second terminal equipment to which the selected destination corresponds.

In some embodiments, the SL DRX active time to which the destination corresponds includes a time length (or a time-domain resource) of the sidelink resources, and the destination has a logical channel or MAC CE with highest priority satisfying a predetermined condition.

In some embodiments, the destination is a destination having a logical channel or MAC CE with highest priority satisfying a predetermined condition selected from third destinations, an SL DRX active time to which the third destinations correspond including the time length (or the time-domain resource) of the sidelink resources.

In some embodiments, the destination is a fourth destination having a logical channel or MAC CE with highest priority satisfying a predetermined condition, wherein when an SL DRX active time to which the fourth destination corresponds includes the time length (or the time-domain resource) of the sidelink resources, a priority of the logical channel and/or MAC CE included in the fourth destination is increased.

In some embodiments, the destination is a fifth destination having a logical channel or MAC CE with highest priority satisfying the predetermined condition, wherein an SL DRX active time to which the fifth destination corresponds includes the time length (or time-domain resource) of the sidelink resources, and the fifth destination has a high priority.

In some embodiments, the destination is a sixth destination having a logical channel or MAC CE with highest priority satisfying the predetermined condition, wherein an SL DRX active time to which the sixth destination corresponds does not include the time length (or time-domain resource) of the sidelink resources, and the sixth destination has a low priority.

In some embodiments, in mode-1, if there exists a second destination having a logical channel or MAC CE with highest priority and an SL DRX active time to which the second destination corresponds does not include the sidelink resources, as shown in FIG. 11, the data transmission apparatus 1100 further includes:
a first triggering unit 1104 configured to trigger an SR or an SL-BSR;
a receiving unit 1105 configured to receive second sidelink resources allocated by the network device; and
a second transmitting unit 1106 configured to transmit second sidelink transmission to the second terminal equipment to which the second destination corresponds by using the second sidelink resources.

In the above embodiment, as shown in FIG. 11, the data transmission apparatus 1100 further includes:
a third transmitting unit 1107 configured to transmit information related on an SL DRX active time to the network device, the information related on an SL DRX active time including SL DRX active time information to which a destination or a pair of source ID and destination ID corresponds.

In some embodiments, in mode-2, if there exists a second destination having a logical channel or MAC CE with highest priority and an SL DRX active time to which the second destination corresponds does not include the sidelink resources, as shown in FIG. 11, the data transmission apparatus 1100 further includes:
a second triggering unit 1108 configured to trigger resource selection and/or reselection to obtain second sidelink resources; and
a fourth transmitting unit 1109 configured to transmit a second sidelink transmission to the second terminal equipment to which the second destination corresponds by using the second sidelink resources.

In the above embodiment, as shown in FIG. 11, the data transmission apparatus 1100 further includes:
a second selecting unit 1110 configured to select a destination associated with the second sidelink resources in the logical channel prioritization (LCP) procedure, the selected destination being the second destination.

It should be noted that the components or modules related to this disclosure are only described above. However, this disclosure is not limited thereto, and the data transmission apparatus 1100 may further include other components or modules, and reference may be made to related techniques for particulars of these components or modules.

Furthermore, for the sake of simplicity, connection relationships between the components or modules or signal profiles are only illustrated in FIG. 11. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

According to the data transmission apparatus of the embodiment of this disclosure, the sidelink resources where the sidelink transmission is located may be made to be located within the DRX active time of the receiving equipment, especially in the case of more than one receiving equipments, it is beneficial for the receiving equipment to correctly receive the sidelink transmission transmitted to itself.

### Embodiment of a Seventh Aspect

The embodiment of this disclosure provides a data transmission apparatus. The apparatus may be a terminal equipment (such as the first terminal equipment described above), or may be one or some components or assemblies configured in the terminal equipment, with contents identical to those in the embodiment of the third aspect being not going to be described herein any further. The apparatus is applicable to a destination (a second destination) having a logical channel or MAC CE with highest priority, and an SL DRX active time to which the second destination corresponds does not include sidelink resources allocated by a network device or autonomously selected by a first transmitting equipment.

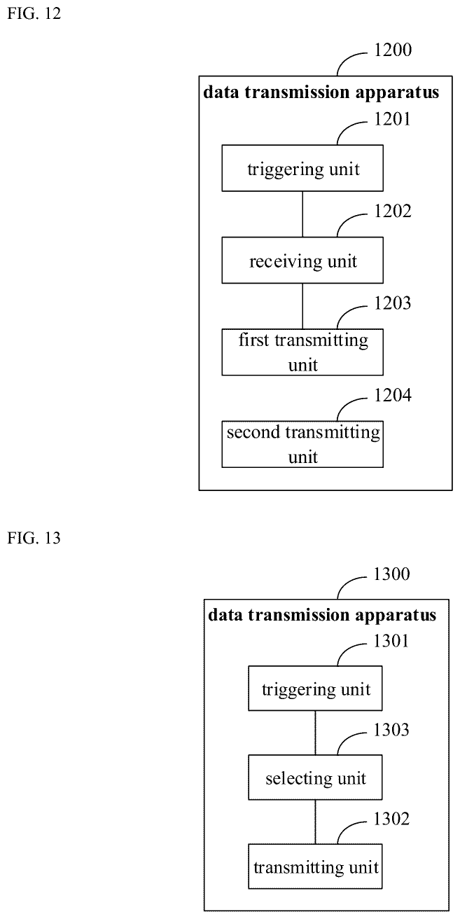

FIG. 12 is a schematic diagram of the data transmission apparatus of the embodiment of this disclosure. As shown in FIG. 12, the data transmission apparatus 1200 includes a triggering unit 1201, a receiving unit 1202 and a first transmitting unit 1203.

The triggering unit 1201 is configured to trigger an SR or an SL-BSR; the receiving unit 1202 is configured to receive second sidelink resources allocated by the network device; and the first transmitting unit 1203 is configured to transmit a second sidelink transmission to a second terminal equipment to which the second destination corresponds by using the second sidelink resources.

In some embodiments, as shown in FIG. 12, the apparatus 1200 further includes:
a second transmitting unit 1204 configured to transmit information related on an SL DRX active time to the network device, the information related on an SL DRX active time including SL DRX active time information to which a destination or a pair of source ID and destination ID corresponds.

FIG. 13 is another schematic diagram of the data transmission apparatus of the embodiment of this disclosure. As shown in FIG. 13, the data transmission apparatus 1300 includes a triggering unit 1301 and a transmitting unit 1302.

The triggering unit 1301 is configured to trigger resource selection/reselection to obtain second sidelink resources; and the transmitting unit 1302 is configured to transmit a second sidelink transmission to the second terminal equipment to which the second destination corresponds by using the second sidelink resources.

In some embodiments, as shown in FIG. 13, the apparatus 1300 further includes:
a selecting unit 1303 configured to select a destination associated with the second sidelink resources in the logical channel prioritization (LCP) procedure, and the selected destination is the second destination.

According to the embodiment of this disclosure, the Rx UE to which the second destination corresponds may correctly receive the sidelink transmission.

### Embodiment of an Eighth Aspect

The embodiment of this disclosure provides a resource scheduling apparatus.

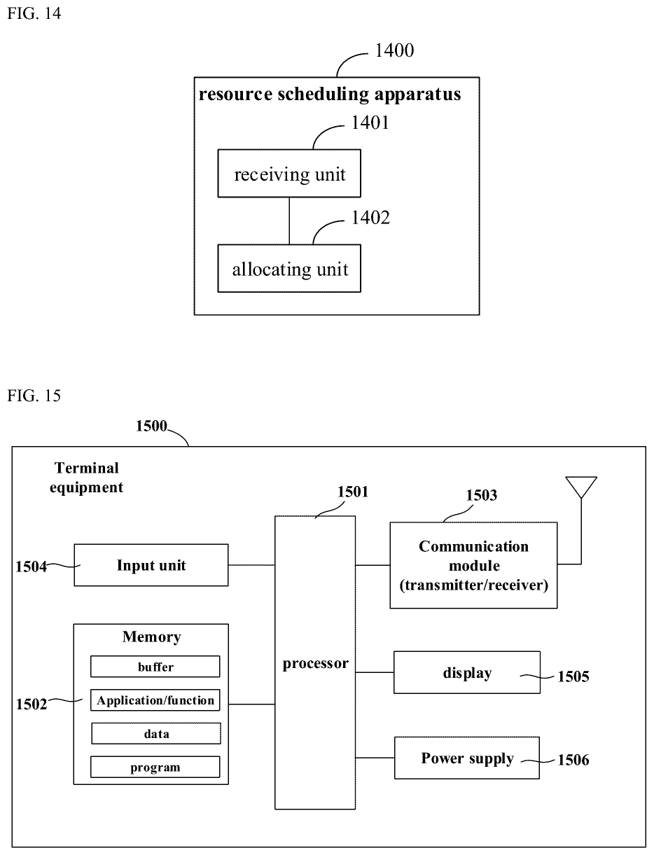

FIG. 14 is a schematic diagram of the resource scheduling apparatus of the embodiment of this disclosure. The apparatus may be a network device, or may be one or some components or assemblies configured in the network device, with contents identical to those in the embodiment of the fourth aspect being not going to be described herein any further.

As shown in FIG. 14, the resource scheduling apparatus 1400 includes: a receiving unit 1401 and an allocating unit 1402.

In the embodiment of this disclosure, the receiving unit 1401 receives information related on an SL DRX active time transmitted by a first terminal equipment, the information related on an SL DRX active time including SL DRX active time information to which a destination or a pair of source ID and destination ID corresponds; and the allocating unit 1402 allocates sidelink resources for the first terminal equipment according to the information related on an SL DRX active time.

In some embodiments, the information related on an SL DRX active time includes SL DRX active time information corresponding to a destination or a pair of source ID and destination ID where a logical channel or MAC CE having a highest priority or having a priority higher than a specific value or having a minimum PDB or having latency requirement less than a specific value is located.

In some embodiments, the information related on an SL DRX active time includes SL DRX active time information to which all destinations or pairs of source IDs and destination IDs correspond.

In the above embodiment, the SL DRX active time information may be at least one of the following: a time period of an SL DRX on-duration timer; a time period of an SL DRX inactivity timer; a time period of an SL DRX retransmission timer; a slot where SL periodic transmission is located; a slot where initial transmission and/or retransmission indicated by SCI is located; and a upper bound of latency of sidelink channel state information (SL CSI) reporting.

According to the resource scheduling apparatus of the embodiment of this disclosure, the sidelink resources where the sidelink transmission is located may be made to be located within the DRX active time of the receiving equipment, especially in the case of more than one receiving equipments, it is beneficial for the receiving equipment to correctly receive the sidelink transmission transmitted to itself.

### Embodiment of a Ninth Aspect

The embodiment of this disclosure provides a communication system, with contents identical to those in the embodiments of the first to eighth aspects being not going to be described herein any further.

In some embodiments, the communication system may at least include a first terminal equipment and a second terminal equipment, the first terminal equipment performing sidelink transmission to the second terminal equipment, and the second terminal equipment using SL DRX. In the embodiment, in mode-2, the first terminal equipment is taken as a transmitting equipment and configured to carry out the method as described in the embodiment of the first aspect or the second aspect or the third aspect, and the second terminal equipment is taken as a receiving equipment and configured to receive sidelink transmission transmitted by the first terminal equipment at an SL DRX active time.

In some embodiments, the communication system may at least include a first terminal equipment, a second terminal equipment and a network device, the first terminal equipment performing sidelink transmission to the second terminal equipment, and the second terminal equipment using SL DRX. In the embodiment, in mode-1, the first terminal equipment is taken as a transmitting equipment and configured to carry out the method as described in the embodiment of the first aspect or the second aspect or the third aspect, the second terminal equipment is taken as a receiving equipment and configured to receive sidelink transmission transmitted by the first terminal equipment at an SL DRX active time, and the network device is configured to allocate sidelink resources for the first terminal equipment.

The embodiment of this disclosure further provides a terminal equipment.

FIG. 15 is a schematic diagram of the terminal equipment of the embodiment of this disclosure. As shown in FIG. 15, the terminal equipment 1500 may include a processor 1501 and a memory 1502, the memory 1502 storing data and a program and being coupled to the processor 1501. It should be noted that this figure is illustrative only, and other types of structures may also be used, so as to supplement or replace this structure and achieve a telecommunications function or other functions.

For example, the processor 1501 may be configured to execute a program to carry out the method as described in the embodiment of the first aspect or the second aspect or the third aspect.

As shown in FIG. 15, the terminal equipment 1500 may further include a communication module 1503, an input unit 1504, a display 1505, and a power supply 1506; wherein functions of the above components are similar to those in the related art, which shall not be described herein any further. It should be noted that the terminal equipment 1500 does not necessarily include all the parts shown in FIG. 15, and the above components are not necessary. Furthermore, the terminal equipment 1500 may include parts not shown in FIG. 15, and the related art may be referred to.

The embodiment of this disclosure further provides a network device.

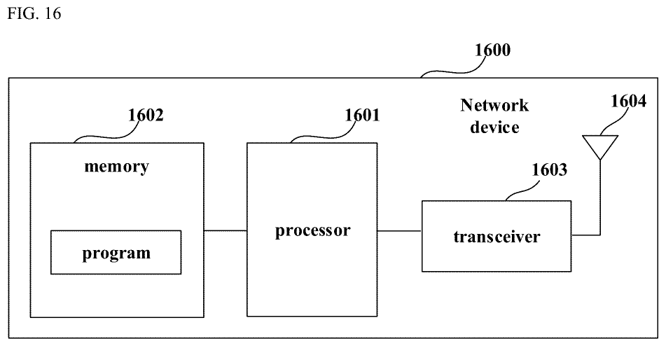

FIG. 16 is a schematic diagram of the network device of the embodiment of this disclosure. As shown in FIG. 16, the network device 1600 may include a processor (such as a central processing unit (CPU)) 1601 and a memory 1602, the memory 1602 being coupled to the processor 1601. In the embodiment, the memory 1602 may store various data, and furthermore, it may store a program for information processing, and execute the program under control of the processor 1601.

For example, the processor 1601 may be configured to execute a program to carry out the method as described in the embodiment of the fourth aspect.

Furthermore, as shown in FIG. 16, the network device 1600 may include a transceiver 1603, and an antenna 1604, etc. In the embodiment, functions of the above components are similar to those in the related art, and shall not be described herein any further. It should be noted that the network device 1600 does not necessarily include all the parts shown in FIG. 16. Furthermore, the network device 1600 may include parts not shown in FIG. 16, and the related art may be referred to.

An embodiment of this disclosure provides a computer readable program, which, when executed in a terminal equipment, will cause the terminal equipment to carry out the method as described in the embodiment of the first aspect or the second aspect or the third aspect.

An embodiment of this disclosure provides a storage medium storing a computer readable program, which will cause a terminal equipment to carry out the method as described in the embodiment of the first aspect or the second aspect or the third aspect.

An embodiment of this disclosure provides a computer readable program, which, when executed in a network device, will cause the network device to carry out the method as described in the embodiment of the fourth aspect.

An embodiment of this disclosure provides a storage medium storing a computer readable program code, which will cause a network device to carry out the method as described in the embodiment of the fourth aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

As to implementations containing the above embodiments, following supplements are further disclosed.
1. A data transmission method, applicable to a first terminal equipment, the first terminal equipment performing sidelink transmission to a second terminal equipment, the second terminal equipment using sidelink discontinuous reception (SL DRX), wherein the method includes:
determining sidelink resources by the first terminal equipment;
selecting a destination associated with the sidelink resources by the first terminal equipment in a logical channel prioritization (LCP) procedure; and
transmitting the sidelink transmission by the first terminal equipment to the second terminal equipment to which the selected destination corresponds.
2. The method according to supplement 1, wherein the destination associated with the sidelink resources is at least one of the following:
a destination where a logical channel or an MAC CE having data to be transmitted is located when a sidelink buffer status report (SL-BSR) is triggered or a control unit of a media access control (MAC CE) of an SL-BSR is generated or an MAC CE of an SL-BSR is transmitted;
a destination where a logical channel or an MAC CE having a highest priority or a minimal packet delay budget (PDB) is located when an SL-BSR is triggered or an MAC CE of an SL-BSR is generated or an MAC CE of an SL-BSR is transmitted; and
a destination where a logical channel or an MAC CE having a highest priority or a minimal PDB is located when a scheduling request (SR) triggered by a sidelink logical channel (SL LCH) or a sidelink MAC CE is triggered or transmitted.
3. The method according to supplement 1 or 2, wherein the method further includes:
transmitting information related on an SL DRX active time by the first terminal equipment to a network device, the information related on the SL DRX active time including SL DRX active time information to which a destination or a pair of source ID and destination ID corresponds.
4. The method according to supplement 3, wherein the information related on an SL DRX active time includes SL DRX active time information corresponding to a destination or a pair of source ID and destination ID where a logical channel or MAC CE having a highest priority or having a priority higher than a specific value or having a minimum PDB or having latency requirement less than a specific value is located.
5. The method according to supplement 3, wherein the information related on an SL DRX active time includes SL DRX active time information to which all destinations or pairs of source IDs and destination IDs correspond.
6. The method according to any one of supplements 3-5, wherein the SL DRX active time information is at least one of the following:
a time period of an SL DRX on-duration timer;
a time period of an SL DRX inactivity timer;
a time period of an SL DRX retransmission timer;
a slot where SL periodic transmission is located;
a slot where initial transmission and/or retransmission indicated by SCI is located; and
an upper bound of latency of sidelink channel state information (SL CSI) reporting.
7. The method according to supplement 1, wherein the destination associated with the sidelink resources is a destination used by the first terminal equipment in a procedure of resource (re)selection.
8. The method according to supplement 7, wherein the destination used by the first terminal equipment in a procedure of resource (re)selection is at least one of the following:
a destination where a logical channel or an MAC CE having a highest priority or a minimal PDB is located when resource (re)selection is triggered;
a destination where a logical channel or an MAC CE having data to be transmitted is located; and
a destination of a second terminal equipment needing coordination of sidelink resources.
9. The method according to supplement 7, wherein the method further includes:
determining the destination used in the procedure of resource (re)selection by the MAC layer of the first terminal equipment, and transmitting assistance information to which the destination corresponds to the physical layer;
selecting a sidelink resource subset by the physical layer of the first terminal equipment according to the assistance information, and reporting the sidelink resource subset to the MAC layer; and
selecting the sidelink resources from the sidelink resource subset by the MAC layer of the first terminal equipment.
10. The method according to supplement 9, wherein the assistance information is SL DRX active time information or sidelink available resources to which the destination corresponds, and the physical layer of the first terminal equipment selects sidelink resources within the SL DRX active time or sidelink available resources to constitute the sidelink resource subset.
11. The method according to supplement 7, wherein the method further includes:
determining the destination used in the procedure of resource (re)selection by the MAC layer of the first terminal equipment, and selecting the sidelink resources from the sidelink resource subset reported by the physical layer of the first terminal equipment according to the assistance information to which the destination corresponds.
12. The method according to supplement 11, wherein the assistance information is SL DRX active time information or sidelink available resources to which the destination corresponds, and the MAC layer of the first terminal equipment selects sidelink resources within the SL DRX active time or sidelink available resources from the sidelink resource subset.
13. The method according to supplement 10 or 12, wherein the SL DRX active time information is at least one of the following:
a time period of an SL DRX on-duration timer;
a time period of an SL DRX inactivity timer;
a time period of an SL DRX retransmission timer;
a slot where SL periodic transmission is located;
a slot where initial transmission and/or retransmission indicated by SCI is located; and
an upper bound of latency of sidelink channel state information (SL CSI) reporting.
14. The method according to supplement 1, wherein if there exists a second destination having a logical channel or MAC CE with highest priority and an SL DRX active time to which the second destination corresponds does not include the sidelink resources, the method further includes:
triggering an SR or an SL-BSR by the first terminal equipment;
receiving, by the first terminal equipment, second sidelink resources allocated by the network device; and
transmitting a second sidelink transmission by the first terminal equipment to a second terminal equipment to which the second destination corresponds by using the second sidelink resources.
15. The method according to supplement 14, wherein the method further includes:
transmitting information related on an SL DRX active time by the first terminal equipment to the network device, the information related on an SL DRX active time including SL DRX active time information to which a destination or a pair of source ID and destination ID corresponds.
16. The method according to supplement 1, wherein if there exists a second destination having a logical channel or MAC CE with highest priority and an SL DRX active time to which the second destination corresponds does not include the sidelink resources, the method further includes:
triggering resource (re)selection by the first terminal equipment to obtain second sidelink resources; and
transmitting a second sidelink transmission by the first terminal equipment to the second terminal equipment to which the second destination corresponds by using the second sidelink resources.
17. The method according to supplement 16, wherein the method further includes:
selecting a destination associated with the second sidelink resources by the first terminal equipment in the logical channel prioritization (LCP) procedure, wherein the selected destination is the second destination.
18. A data transmission method, applicable to a first terminal equipment, the first terminal equipment performing sidelink transmission to a second terminal equipment, the second terminal equipment using sidelink discontinuous reception (SL DRX), wherein the method includes:
determining sidelink resources by the first terminal equipment;
selecting a destination by the first terminal equipment in a logical channel prioritization (LCP) procedure, wherein the sidelink resources are located within an SL DRX active time to which the destination corresponds; and
transmitting the sidelink transmission by the first terminal equipment to the second terminal equipment to which the selected destination corresponds.
19. The method according to supplement 18, wherein the SL DRX active time to which the destination corresponds includes a time length of the sidelink resources, and the destination has a logical channel or MAC CE with highest priority satisfying a predetermined condition.
20. The method according to supplement 18, wherein the destination is a destination having a logical channel or MAC CE with highest priority satisfying a predetermined condition selected from third destinations, an SL DRX active time to which the third destinations correspond including the time length of the sidelink resources.
21. The method according to supplement 18, wherein the destination is a fourth destination having a logical channel or MAC CE with highest priority satisfying a predetermined condition, wherein when an SL DRX active time to which the fourth destination corresponds includes the time length of the sidelink resources, a priority of the logical channel and/or MAC CE included in the fourth destination is increased.
22. The method according to supplement 18, wherein if there exists a second destination having a logical channel or MAC CE with highest priority and an SL DRX active time to which the second destination corresponds does not include the sidelink resources, the method further includes:
triggering an SR or an SL-BSR by the first terminal equipment;
receiving, by the first terminal equipment, second sidelink resources allocated by the network device; and
transmitting a second sidelink transmission by the first terminal equipment to the second terminal equipment to which the second destination corresponds by using the second sidelink resources.
23. The method according to supplement 22, wherein the method further includes:
transmitting information related on an SL DRX active time by the first terminal equipment to the network device, the information related on an SL DRX active time including SL DRX active time information to which a destination or a pair of source ID and destination ID corresponds.
24. The method according to supplement 18, wherein if there exists a second destination having a logical channel or MAC CE with highest priority and an SL DRX active time to which the second destination corresponds does not include the sidelink resources, the method further includes:
triggering resource (re)selection by the first terminal equipment to obtain second sidelink resources; and
transmitting a second sidelink transmission by the first terminal equipment to the second terminal equipment to which the second destination corresponds by using the second sidelink resources.
25. The method according to supplement 24, wherein the method further includes:
selecting a destination associated with the second sidelink resources by the first terminal equipment in the logical channel prioritization (LCP) procedure, wherein the selected destination is the second destination.
26. A data transmission method, applicable to a first terminal equipment, the first terminal equipment performing sidelink transmission to a second terminal equipment, the second terminal equipment using sidelink discontinuous reception (SL DRX), wherein the method includes:
for a second destination having a logical channel or MAC CE with highest priority, if an SL DRX active time to which the second destination corresponds does not include the sidelink resources,
triggering an SR or an SL-BSR by the first terminal equipment;
receiving, by the first terminal equipment, second sidelink resources allocated by the network device; and
transmitting a second sidelink transmission by the first terminal equipment to the second terminal equipment to which the second destination corresponds by using the second sidelink resources.
27. The method according to supplement 26, wherein the method further includes:
transmitting information related on an SL DRX active time by the first terminal equipment to the network device, the information related on an SL DRX active time including SL DRX active time information to which a destination or a pair of source ID and destination ID corresponds.
28. A data transmission method, applicable to a first terminal equipment, the first terminal equipment performing sidelink transmission to a second terminal equipment, the second terminal equipment using sidelink discontinuous reception (SL DRX), wherein the method includes:
for a second destination having a logical channel or MAC CE with highest priority, if an SL DRX active time to which the second destination corresponds does not include the sidelink resources,
triggering resource selection/reselection by the first terminal equipment to obtain second sidelink resources; and
transmitting a second sidelink transmission by the first terminal equipment to the second terminal equipment to which the second destination corresponds by using the second sidelink resources.
29. The method according to supplement 28, wherein the method further includes:
selecting a destination associated with the second sidelink resources by the first terminal equipment in the logical channel prioritization (LCP) procedure, the selected destination being the second destination.
30. A resource scheduling method, applicable to a network device, the network device allocating sidelink resources for a first terminal equipment, wherein the method includes:
receiving, by the network device, information related on an SL DRX active time transmitted by a first terminal equipment, the information related on an SL DRX active time including SL DRX active time information to which a destination or a pair of source ID and destination ID corresponds; and
allocating sidelink resources by the network device for the first terminal equipment according to the information related on an SL DRX active time.
31. The method according to supplement 30, wherein the information related on an SL DRX active time includes SL DRX active time information corresponding to a destination or a pair of source ID and destination ID where a logical channel or MAC CE having a highest priority or having a priority higher than a specific value or having a minimum PDB or having latency requirement less than a specific value is located.
32. The method according to supplement 30, wherein the information related on an SL DRX active time includes SL DRX active time information to which all destinations or pairs of source IDs and destination IDs correspond.
33. The method according to any one of supplements 30-32, wherein the SL DRX active time information is at least one of the following:
a time period of an SL DRX on-duration timer;
a time period of an SL DRX inactivity timer;
a time period of an SL DRX retransmission timer;
a slot where SL periodic transmission is located;
a slot where initial transmission and/or retransmission indicated by SCI is located; and
an upper bound of latency of sidelink channel state information (SL CSI) reporting.
34. A terminal equipment, including a memory and a processor, the memory storing a computer program, and the processor being configured to execute the computer program to carry out the method as described in any one of supplements 1-29.
35. A network device, including a memory and a processor, the memory storing a computer program, and the processor being configured to execute the computer program to carry out the method as described in any one of supplements 30-33.
36. A communication system, including a first terminal equipment and a second terminal equipment, the first terminal equipment performing sidelink transmission to the second terminal equipment, and the second terminal equipment using sidelink discontinuous reception SL DRX, wherein,
the first terminal equipment determines sidelink resources, selects a destination associated with the sidelink resources in a logical channel prioritization (LCP) procedure, and transmits the sidelink transmission to the second terminal equipment to which the selected destination corresponds;
and the second terminal equipment receives the sidelink transmission.
37. A communication system, including a first terminal equipment and a second terminal equipment, the first terminal equipment performing sidelink transmission to the second terminal equipment, and the second terminal equipment using sidelink discontinuous reception SL DRX, wherein,
the first terminal equipment determines sidelink resources, selects a destination in a logical channel prioritization (LCP) procedure, and transmits the sidelink transmission to the second terminal equipment to which the selected destination corresponds, wherein the sidelink resources are located within an SL DRX active time to which the destination corresponds;
and the second terminal equipment receives the sidelink transmission.
38. A communication system, including a first terminal equipment, a second terminal equipment and a network device, the first terminal equipment performing sidelink transmission to the second terminal equipment, and the second terminal equipment using SL DRX, wherein,
the network device receives information related on an SL DRX active time transmitted by the first terminal equipment, the information related on an SL DRX active time including SL DRX active time information to which a destination or a pair of source ID and destination ID corresponds, and allocates sidelink resources for the first terminal equipment according to the information related on an SL DRX active time;
and the first terminal equipment transmits sidelink transmission to the second terminal equipment by using the sidelink resources.

1. A data transmission apparatus, configured in a first terminal equipment, the first terminal equipment performing sidelink transmission to a second terminal equipment, the second terminal equipment performing sidelink discontinuous reception (SL DRX), the data transmission apparatus comprising:
a processor configured to:
determine a sidelink resource; and
select a destination associated with the sidelink resources in a logical channel prioritization (LCP) procedure; and
a transmitter configured to transmit the sidelink transmission to the second terminal equipment to which the selected destination corresponds, wherein the sidelink resource being located within the SL DRX active time to which the destination corresponds.

2. The data transmission apparatus according to claim 1, wherein the destination associated with the sidelink resource is at least one of the following:
a destination where a logical channel or an MAC CE having data to be transmitted is located when a sidelink buffer status report (SL-BSR) is triggered or a control unit of a media access control (MAC CE) of an SL-BSR is generated or an MAC CE of an SL-BSR is transmitted;
a destination where a logical channel or an MAC CE having a highest priority or a minimal packet delay budget (PDB) is located when an SL-BSR is triggered or an MAC CE of an SL-BSR is generated or an MAC CE of an SL-BSR is transmitted; and
a destination where a logical channel or an MAC CE having a highest priority or a minimal PDB is located when a scheduling request (SR) triggered by a sidelink logical channel (SL LCH) or a sidelink MAC CE is triggered or transmitted.

3. The data transmission apparatus according to claim 1, wherein,
the transmitter is further configured to transmit information related on an SL DRX active time to a network device, the information related on the SL DRX active time including SL DRX active time information to which a destination or a pair of source ID and destination ID corresponds.

4. The data transmission apparatus according to claim 3, wherein the SL DRX active time information is at least one of the following:
a time period of an SL DRX on-duration timer;
a time period of an SL DRX inactivity timer;
a time period of an SL DRX retransmission timer;
a slot where SL periodic transmission is located;
a slot where initial transmission and/or retransmission indicated by SCI is located; and
an upper bound of latency of sidelink channel state information (SL CSI) reporting.

5. The data transmission apparatus according to claim 1, wherein the destination associated with the sidelink resource is a destination used by the first terminal equipment in a procedure of resource (re)selection.

6. The data transmission apparatus according to claim 5, wherein the destination used by the first terminal equipment in a procedure of resource (re)selection is at least one of the following:
a destination where a logical channel or an MAC CE having a highest priority or a minimal PDB is located when resource (re)selection is triggered;
a destination where a logical channel or an MAC CE having data to be transmitted is located; and
a destination of a second terminal equipment needing coordination of sidelink resources.

7. The data transmission apparatus according to claim 1, wherein the apparatus further comprises:
the processor is further configured to determine the destination used in the procedure of resource (re)selection at the MAC layer of the first terminal equipment, notify assistance information to which the destination corresponds to the physical layer of the first terminal equipment, select a sidelink resource subset at the physical layer of the first terminal equipment according to the assistance information and report the sidelink resource subset to the MAC layer, and select the sidelink resources from the sidelink resource subset at the MAC layer of the first terminal equipment.

8. The data transmission apparatus according to claim 7, wherein the assistance information is SL DRX active time information or sidelink available resources to which the destination corresponds, and the physical layer of the first terminal equipment selects sidelink resources within the SL DRX active time or sidelink available resources to constitute the sidelink resource subset.

9. The data transmission apparatus according to claim 1, wherein the apparatus further comprises:
the processor is further configured to determine the destination used in the procedure of resource (re)selection at the MAC layer of the first terminal equipment, and select the sidelink resources from the sidelink resource subset reported by the physical layer of the first terminal equipment according to the assistance information to which the destination corresponds.

10. The data transmission apparatus according to claim 9, wherein the assistance information is SL DRX active time information or sidelink available resources to which the destination corresponds, and the MAC layer of the first terminal equipment selects sidelink resources within the SL DRX active time or sidelink available resources from the sidelink resource subset.

11. The data transmission apparatus according to claim 8, wherein the SL DRX active time information is at least one of the following:
a time period of an SL DRX on-duration timer;
a time period of an SL DRX inactivity timer;
a time period of an SL DRX retransmission timer;
a slot where SL periodic transmission is located;
a slot where initial transmission and/or retransmission indicated by SCI is located; and
an upper bound of latency of sidelink channel state information (SL CSI) reporting.

12. The data transmission apparatus according to claim 1, wherein the data transmission apparatus further comprising:
a receiver configured to receive second sidelink resources allocated by the network device; wherein,
the processor is further configured to trigger, if there exists a second destination having a logical channel or MAC CE with highest priority and an SL DRX active time to which the second destination corresponds does not include the sidelink resource, an SR or an SL-BSR;
the transmitter is further configured to transmit a second sidelink transmission to a second terminal equipment to which the second destination corresponds by using the second sidelink resources.

13. The data transmission apparatus according to claim 1, wherein,
the processor is further configured to trigger, if there exists a second destination having a logical channel or MAC CE with highest priority and an SL DRX active time to which the second destination corresponds does not include the sidelink resource, resource (re)selection to obtain second sidelink resources;
the transmitter is further configured to transmit a second sidelink transmission to the second terminal equipment to which the second destination corresponds by using the second sidelink resources.

14. A data transmission apparatus, configured in a first terminal equipment, the first terminal equipment performing sidelink transmission to a second terminal equipment, the second terminal equipment performing sidelink discontinuous reception (SL DRX), wherein the data transmission apparatus comprising:
a processor configured to:
determine sidelink resources; and
select a destination in a logical channel prioritization (LCP) procedure, wherein the sidelink resources are located within an SL DRX active time to which the destination corresponds; and
a transmitter configured to transmit the sidelink transmission to the second terminal equipment to which the selected destination corresponds.

15. The data transmission apparatus according to claim 14, wherein the SL DRX active time to which the destination corresponds includes a time length of the sidelink resources, and the destination has a logical channel or MAC CE with highest priority satisfying a predetermined condition.

16. The data transmission apparatus according to claim 14, wherein the destination is a destination having a logical channel or MAC CE with highest priority satisfying a predetermined condition selected from third destinations, an SL DRX active time to which the third destinations correspond including the time length of the sidelink resources.

17. The data transmission apparatus according to claim 14, wherein the destination is a fourth destination having a logical channel or MAC CE with highest priority satisfying a predetermined condition, wherein when an SL DRX active time to which the fourth destination corresponds includes the time length of the sidelink resources, a priority of the logical channel and/or MAC CE included in the fourth destination is increased.

18. The data transmission apparatus according to claim 14, further comprising:
a receiver configured to receive second sidelink resources allocated by the network device; wherein,
the processor is further configured to trigger, if there exists a second destination having a logical channel or MAC CE with highest priority and an SL DRX active time to which the second destination corresponds does not include the sidelink resources, an SR or an SL-BSR;
the transmitter is further configured to transmit a second sidelink transmission to the second terminal equipment to which the second destination corresponds by using the second sidelink resources.

19. The data transmission apparatus according to claim 14, wherein,
the processor is further configured to trigger, if there exists a second destination having a logical channel or MAC CE with highest priority and an SL DRX active time to which the second destination corresponds does not include the sidelink resources, resource (re)selection to obtain second sidelink resources; and
the transmitter is further configured to transmit a second sidelink transmission to the second terminal equipment to which the second destination corresponds by using the second sidelink resources.

20. A communication system, comprising:
a first terminal equipment; and
a second terminal equipment configured to perform sidelink discontinuous reception (SL DRX), wherein,
the first terminal equipment is further configured to:
perform sidelink transmission to the second terminal equipment, the second terminal equipment,
determine sidelink resources,
selects a destination in a logical channel prioritization (LCP) procedure, and
transmit the sidelink transmission to the second terminal equipment to which the selected destination corresponds, wherein the sidelink resources are located within an SL DRX active time to which the destination corresponds, and
the second terminal equipment is configured to receive the sidelink transmission.
